(19) United States
(12) Patent Application Publication
(10) Pub. No.: US 2006/0053764 A1
(43) Pub. Date: Mar. 16, 2006

(54) Method and device for husking and degerminating cereals

(76) Inventors: Othmar Gerschwiler, Jonschwil (CH); Walter Eugster, Niederuzwil (CH); Urs Zwahlen, Oberuzwil (CH)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/533,590

(22) PCT Filed: Jan. 27, 2003
(86) PCT No.: PCT/CH03/00061

§ 371 Date: May 3, 2005

(30) Foreign Application Priority Data
Nov. 4, 2002 (DE) 102 51 490.9

(51) Int. Cl. A01D 45/30; B07B 1/00

(52) U.S. Cl. 56/126; 209/268

(57) ABSTRACT

The invention relates to a method and a device for husking and degerminating grains of maize. The aim of the invention is to provide an efficient and simple degermination of maize. To this end, during a wet degermination process, cleaned maize is wetted, and then husked and degerminated, and directly supplied to the comminution stage.

The invention relates to a process and a device for husking and seeding grains and the like, in particular corn.

A device for husking and seeding corn grains is known from WO 89/00454. This device has a stator, in the housing whereof a rotor is swivel-mounted horizontal, which is fed with naps at least partially in the region of the processing space. The interior of the stator housing delimiting the processing space has screening elements fitted with a screen perforation and contains at least two detachable housing wall parts. At least the detachable housing wall parts each have at least a nap segment, which can be adjusted radially to the axis of rotation of the rotor.

The corn grains are first prepared with water and/or steam, then husked and seeded and the husk-free discard is sifted and further processed. The screenings is sifted separately.

Also known is a husking machine with vertically arranged rotor, whereof the discard is guided into a polishing machine and if required another screen is arranged between both machines. The corn grains are husked by this process, then polished, aspirated and again wet. This is followed by standing for 10 min. prior to milling.

The object of the invention is to develop a process for husking and seeding corn grains, which enables further simplification of the process at a higher yield and product quality. This task is solved by the characteristics of claim 1. Cleaned and wet corn is husked and seeded and the husked corn grains are fed directly to processing/comminution.

If required, just one more sifting is arranged upstream, for example in an aspiration channel of the processing.

The processing itself is substantially simplified, the plant and maintenance costs decrease and operating is simplified. Surprisingly, yields and product quality as well as efficiency could be massively increased, in particular during the dry seeding process. Machinery costs in comminution to grits can also be noticeably reduced.

A further object of the invention comprises creating a device for husking and seeding corn grains. This object is solved by the characteristics of claim 5. The device has a processing zone with adaptable baffles and a rotor with projections over the length of the processing zone and air slots. The distance between strainer basket and rotor is variable.

The invention will now be described in greater detail hereinbelow in an embodiment by means of a diagram, in which:

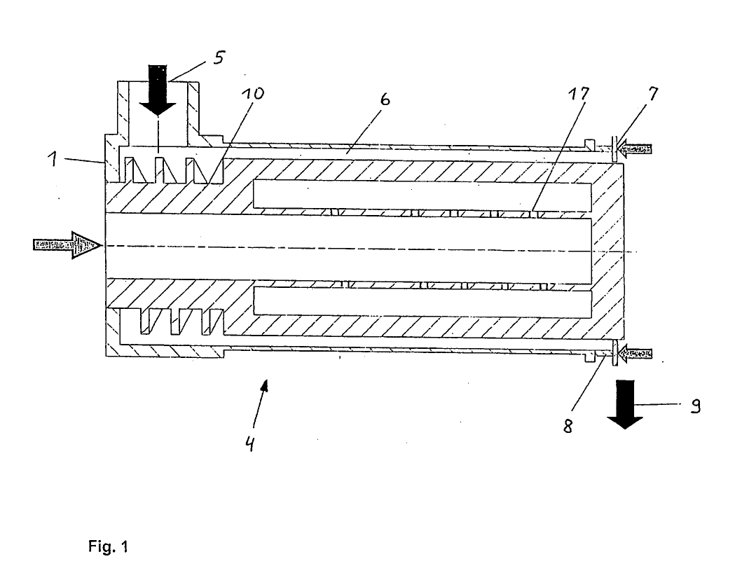

FIG. 1 illustrates a device in section,

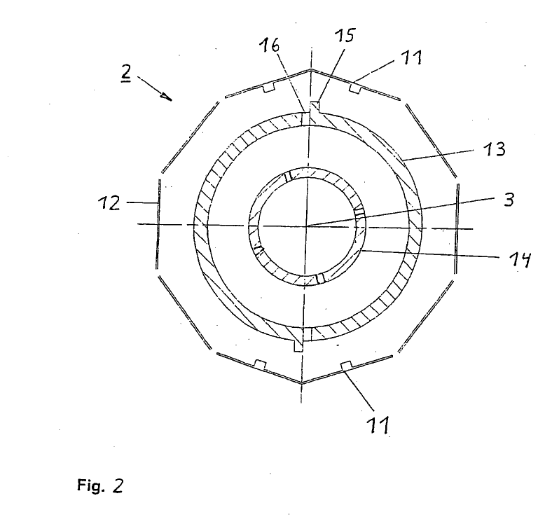

FIG. 2 illustrates a cross-section of the processing zone,

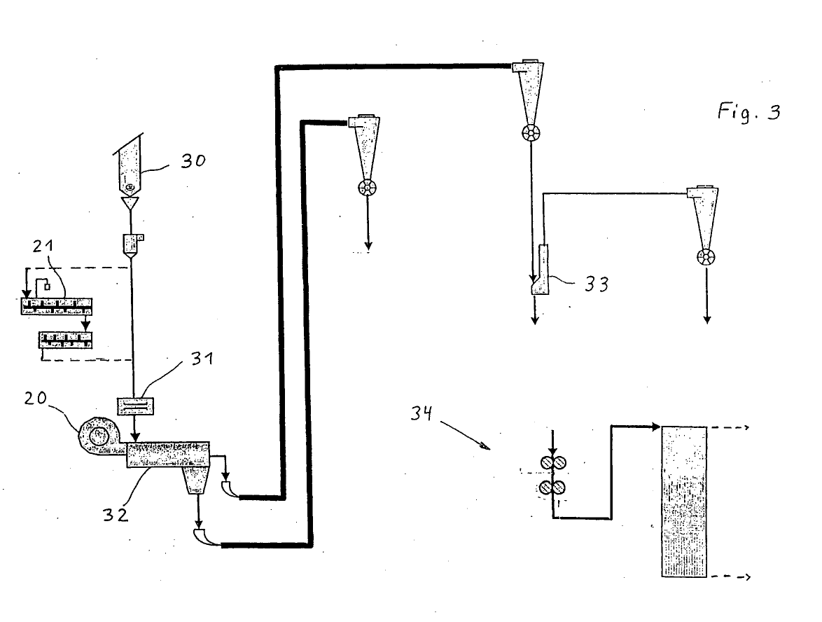

FIG. 3 illustrates a procedural diagram.

The stator 1 of the device (corn seeding machine 32) has a housing 2, which surrounds a rotor 3 mounted therein, and is mounted on a frame and is open downwards through a connecting discharge 4. Via this discharge 4 the screenings are discarded from seeds, husk meal and husking parts.

The corn grains enter the processing zone 6 via a feed screw 10 from a product inlet 5. During husking/seeding the corn grains are guided against an adjustable storage device 7, in order to develop a specific processing pressure in the processing zone 6. The seeded corn grains leave the processing zone 6 via an adjustable discharge opening 5 and via a discharge 9 of the seeding machine.

The processing zone on the stator side is formed by four baffles 11 and two strainer basket halves 12, whereby every two baffles 11 are arranged above and two are arranged below on the stator 1 and in between the strainer basket halves 12 are arranged such that they fully encircle the rotor 3 with the baffles 11 in an axial direction. The rotor 3 is composed of a cast roller 13 with a hollow shaft 14. The roller 13 contains at least two projections 15 and assigned slots 16, which are arranged on the periphery of the roller 13 spaced uniformly from one another, and which extend over the entire length of the processing zone 6.

The hollow shaft 14 has a plurality of openings 17 for the discharge of air. The air enters the processing zone 6 through the slots 16 in the roller 13 and supports the product passing through the screen. The air is pressed into the hollow shaft 14 by means of a ventilator 20.

With moist seeding cleaned and wet corn is fed to the corn-seeding machine 32 via a metering device 30 and a magnet 31, where it is husked and seeded. Surface wetting (husk wetting) of the grains during wetting in the wetting unit 21 takes place briefly only. The screenings comprises husk and husk meal, and the discard of seeded corn grains enters an aspiration channel 33, where loosened husking parts are separated in the air current. The aspirated corn grains enter the mill and the first two milling passes (B1, B2) 34 are run through without intermediate sifting (according to the teaching of EP-B-335925). Only after the second comminution stage are the grits sifted and sent on to further milling passes.

During dry seeding surface wetting in the wetting unit 21 is dispensed with and only seeding takes place. This results in an essentially higher yield, similar to conventional wet seeding.

During wet seeding it is possible to markedly increase output. The product quality remains constant.

On account of the smaller machine park plant costs fall substantially, and maintenance costs and staff expenditure also drop.

The invention is not limited to this exemplary embodiment.

### LEGEND

1 stator
2 housing
3 rotor
4 discharge
5 product inlet
6 processing zone
7 storage device
8 discharge opening
9 discharge
10 feed screw
11 baffle
12 strainer basket half
13 roller
14 hollow shaft
15 projection
16 slot
17 opening
20 ventilator
21 wetting unit
30 metering device
31 magnet
32 corn seeding machine
33 aspiration channel
34 milling pass

1. A process for husking and seeding grains and the like, in particular corn grains, whereby the grains are first cleaned, characterised in that the grains are seeded immediately or after surface wetting.

2. The process as claimed in claim 1, characterised in that the grains are only seeded by dry seeding.

3. The process as claimed in claim 1 or 2, characterised in that the husking and/or seeding takes place in a processing zone (6) between baffles (11) of a roller (13), whereby the roller (13) has projections.

4. The process as claimed in claim 1, characterised in that the seeded corn grains are aspirated and milled into grits or meal.

5. The process as claimed in claim 4, characterised in that comminution begins with double milling without intermediate sifting between the comminution stages.

6. A device for husking and seeding grains, in particular corn grains with a swivel-mounted rotor, equipped with processing tools and a stator (1), which contains processing tools and screen enclosing the rotor to form a processing zone (6), characterised in that the rotor (3) comprises a hollow shaft (14), which is enclosed in the region of the processing zone (6) by an outer roller (13), whereby the roller (13) has at least two projections (15).

7. The device as claimed in claim 6, characterised in that the projections (15) extend over the processing zone (6).

8. The device as claimed in claim 7, characterised in that the projections (15) are arranged distributed over the periphery of the roller (13) spaced uniformly from one another.

9. The device as claimed in at least one of claims 6 to 8, characterised in that the projections (15) are assigned slots (16).

10. The device as claimed in claim 6, characterised in that the hollow shaft (14) is connected to a ventilator (20) and has openings (17) in the region of the processing zone (6).
